(19) United States
(12) Patent Application Publication
(10) Pub. No.: US 2015/0002271 A1
(43) Pub. Date: Jan. 1, 2015

(54) VARIABLE LISTEN DURATION AND/OR SYNCHRONIZED WAKE-UP OF ASSET TAGS

(71) Applicant: QUALCOMM Incorporated, San Diego, CA (US)

(72) Inventors: Jangwon Lee, San Diego, CA (US); Gregory Gordon Rose, San Diego, CA (US); An Mei Chen, San Diego, CA (US)

(73) Assignee: QUALCOMM Incorporated, San Diego, CA (US)

(21) Appl. No.: 14/151,705

(22) Filed: Jan. 9, 2014

Related U.S. Application Data
(60) Provisional application No. 61/840,379, filed on Jun. 27, 2013.

(51) Int. Cl. G01S 3/04

(52) U.S. Cl. CPC G01S 3/04
USPC 340/10.1

(57) ABSTRACT

A method of obtaining information for locating an asset includes: listening, at an asset tag, for a first listen duration for landmark messages; receiving, at the asset tag during the first listen duration, at least one landmark message from each of one or more landmark tags; selecting a synched landmark tag from the one or more landmark tags; abstaining from listening, at the asset tag, for landmark messages until approximately a subsequent transmission time of a synched landmark message corresponding to the synched landmark tag; and waking up at approximately the subsequent transmission time of the synched landmark message to listen, at the asset tag, for landmark messages for a second listen duration such that the asset tag listens for the landmark messages during the subsequent transmission time; wherein the first listen duration is longer than the second listen duration.

### CROSS-REFERENCE TO RELATED APPLICATIONS

This application claims the benefit of U.S. Provisional Application No. 61/840,379, filed Jun. 27, 2013, entitled “VARIABLE LISTEN DURATION AND/OR SYNCHRONIZED WAKE-UP OF ASSET TAGS,” which is incorporated herein by reference in its entirety for all purposes.

### BACKGROUND

Asset tracking systems are used to assist in a variety of tasks, such as inventory control, manufacturing status tracking, etc. As the use of asset tracking systems becomes more widespread, it is becoming increasingly desirable to implement an efficient and practical indoor asset tracking system. One desirable feature of such an indoor asset tracking system is longevity of the components of the system. This may be considered in terms of durability, battery life, etc. For example, it is desirable for an asset tag used for positioning of an associated object to have a long battery life (e.g., 2-3 years or greater).

### SUMMARY

An example of a method of obtaining information for locating an asset includes: listening, at an asset tag, for a first listen duration for landmark messages; receiving, at the asset tag during the first listen duration, at least one landmark message from each of one or more landmark tags; selecting a synched landmark tag from the one or more landmark tags; abstaining from listening, at the asset tag, for landmark messages until approximately a subsequent transmission time of a synched landmark message corresponding to the synched landmark tag; and waking up at approximately the subsequent transmission time of the synched landmark message to listen, at the asset tag, for landmark messages for a second listen duration such that the asset tag listens for the landmark messages during the subsequent transmission time; where the first listen duration is longer than the second listen duration.

Implementations of such a method may include one or more of the following features. The one or more landmark tags include a plurality of landmark tags including one or more landmark tags of a first type and one or more landmark tags of a second type, and where selecting the synched landmark tag comprises determining, at the asset tag, a received signal strength corresponding to each of the one or more landmark tags of the first type and selecting as the synched landmark tag the landmark tag of the first type corresponding to a highest determined received signal strength of a corresponding landmark message. The one or more landmark tags of the second type have a higher transmission power and a higher landmark message transmission frequency than the one or more landmark tags of the first type. The asset tag listens for the second duration multiple instances between consecutive instances of listening for the first listen duration. The asset tag changes from listening for the second listen duration to listening for the first listen duration in response to: receiving a landmark message from a landmark tag from which no landmark message was received in a most-recent instance of listening for the second listen duration or in a most-recent instance of listening for the first listen duration; or a received signal strength of a landmark message received from the synched landmark tag during the second duration being significantly different from a previously-received signal strength of a previously-received landmark message from the synched landmark tag. The second listen duration is long enough that the asset tag listens during an entire transmission window of the synched landmark message.

An example of an asset tag includes: a wireless communication module communicatively; a memory; and a processor, communicatively coupled to the wireless communication module and the memory, configured to: cause the wireless communication module to listen for a first listen duration for landmark messages; select a synched landmark tag from one or more landmark tags from each of which at least one landmark message is received during the first listen duration; cause the wireless communication module to abstain from listening for landmark messages until approximately a subsequent transmission time of a synched landmark message corresponding to the synched landmark tag; and cause the wireless communication module to wake up at approximately the subsequent transmission time of the synched landmark message to listen for landmark messages for a second listen duration such that the asset tag listens for the landmark messages during the subsequent transmission time; where the first listen duration is longer than the second listen duration.

Implementations of such an asset tag may include one or more of the following features. The processor is configured to select the synched landmark tag by determining a received signal strength corresponding to each of one or more landmark tags of a first type, from among one or more landmark tags of the first type and one or more landmark tags of a second type of the one or more landmark tags from each of which at least one landmark message is received during the first listen duration, and selecting as the synched landmark tag the landmark tag of the first type corresponding to a highest determined received signal strength of a corresponding landmark message. The one or more landmark tags of the second type have a higher transmission power and a higher landmark message transmission frequency than the one or more landmark tags of the first type. The processor is configured to cause the wireless communication module to listen for the second duration multiple instances between consecutive instances of listening for the first listen duration. The processor is configured to cause the wireless communication module to change from listening for the second listen duration to listening for the first listen duration in response to: the wireless communication module receiving a landmark message from a landmark tag from which no landmark message was received in a most-recent instance of listening for the second listen duration or in a most-recent instance of listening for the first listen duration; or a received signal strength of a landmark message received from the synched landmark tag during the second duration being significantly different from a previously-received signal strength of a previously-received landmark message from the synched landmark tag. The second listen duration is long enough that the wireless communication module listens during an entire transmission window of the synched landmark message.

Another example of an asset tag includes: wireless communication means for communicating with landmark tags; processor means, communicatively coupled to the wireless communication module and the memory, for: causing the wireless communication module to listen for a first listen duration for landmark messages; selecting a synched landmark tag from one or more landmark tags from each of which at least one landmark message is received during the first listen duration; causing the wireless communication module to abstain from listening for landmark messages until approximately a subsequent transmission time of a synched landmark message corresponding to the synched landmark tag; and causing the wireless communication module to wake up at approximately the subsequent transmission time of the synched landmark message to listen for landmark messages for a second listen duration such that the asset tag listens for the landmark messages during the subsequent transmission time; where the first listen duration is longer than the second listen duration.

Implementations of such an asset tag may include one or more of the following features. The processor means are configured to select the synched landmark tag by determining a received signal strength corresponding to each of one or more landmark tags of a first type, from among one or more landmark tags of the first type and one or more landmark tags of a second type of the one or more landmark tags from each of which at least one landmark message is received during the first listen duration, and selecting as the synched landmark tag the landmark tag of the first type corresponding to a highest determined received signal strength of a corresponding landmark message. The one or more landmark tags of the second type have a higher transmission power and a higher landmark message transmission frequency than the one or more landmark tags of the first type. The processor means are configured to cause the wireless communication module to listen for the second duration multiple instances between consecutive instances of listening for the first listen duration. The processor means are further for causing the wireless communication module to change from listening for the second listen duration to listening for the first listen duration in response to: the wireless communication module receiving a landmark message from a landmark tag from which no landmark message was received in a most-recent instance of listening for the second listen duration or in a most-recent instance of listening for the first listen duration; or a received signal strength of a landmark message received from the synched landmark tag during the second duration being significantly different from a previously-received signal strength of a previously-received landmark message from the synched landmark tag. The second listen duration is long enough that the wireless communication module listens during an entire transmission window of the synched landmark message.

An example of a processor-readable storage medium includes processor-readable instructions configured to cause a processor to: cause a wireless communication module to listen for a first listen duration for landmark messages; select a synched landmark tag from one or more landmark tags from each of which at least one landmark message is received during the first listen duration; cause the wireless communication module to abstain from listening for landmark messages until approximately a subsequent transmission time of a synched landmark message corresponding to the synched landmark tag; and cause the wireless communication module to wake up at approximately the subsequent transmission time of the synched landmark message to listen for landmark messages for a second listen duration such that the asset tag listens for the landmark messages during the subsequent transmission time; where the first listen duration is longer than the second listen duration.

Implementations of such a storage medium may include one or more of the following features. The instructions configured to cause the processor to select are configured to cause the processor to determine a received signal strength corresponding to each of one or more landmark tags of a first type, from among one or more landmark tags of the first type and one or more landmark tags of a second type of the one or more landmark tags from each of which at least one landmark message is received during the first listen duration, and to select as the synched landmark tag the landmark tag of the first type corresponding to a highest determined received signal strength of a corresponding landmark message. The one or more landmark tags of the second type have a higher transmission power and a higher landmark message transmission frequency than the one or more landmark tags of the first type. The instructions configured to cause the processor to cause the wireless communication module to listen for the second duration are configured to cause the processor to cause the wireless communication module to listen for the second duration multiple instances between consecutive instances of listening for the first listen duration. The processor-readable storage medium further includes instructions configured to cause the processor to cause the wireless communication module to change from listening for the second listen duration to listening for the first listen duration in response to: the wireless communication module receiving a landmark message from a landmark tag from which no landmark message was received in a most-recent instance of listening for the second listen duration or in a most-recent instance of listening for the first listen duration; or a received signal strength of a landmark message received from the synched landmark tag during the second duration being significantly different from a previously-received signal strength of a previously-received landmark message from the synched landmark tag. The second listen duration is long enough that the wireless communication module listens during an entire transmission window of the synched landmark message.

Items and/or techniques discussed herein may provide one or more of the following capabilities, as well as other capabilities not mentioned. Battery life of asset tags may be extended. Signal processing in an asset tag may be reduced by varying listen durations and/or synchronizing listen windows of an asset tag with landmark messages sent by landmark tags. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTIONS OF THE DRAWINGS

FIG. 1 is a block diagram of an asset tracking environment including an asset tracking system.

FIG. 2 is a block diagram of an asset tag shown in FIG. 1.

FIG. 3 is a block diagram of a landmark tag shown in FIG. 1.

FIG. 4 is a block diagram of a receiver shown in FIG. 1.

FIG. 5 is a block diagram of a server shown in FIG. 1.

FIG. 6 is a timing diagram of asset tag listen, transmission, and sleep periods and associated landmark tag sleep and transmission periods.

FIG. 7 is a timing diagram of an asset tag listen period in the absence of an associated landmark tag transmission period.

FIG. 8 is a block diagram of another asset tracking environment.

FIG. 9 is a schematic diagram of two tiers of landmark tag coverage areas.

FIG. 10 is a block diagram of an asset tracking environment using relay tags.

FIG. 11 is a block diagram of a relay tag shown in FIG. 10.

FIG. 12 is a block diagram of a location-aware content distribution system.

FIG. 13 is a block diagram of a mobile device shown in FIG. 12.

FIG. 14 is a timing diagram of landmark message transmissions and asset tag listen windows.

FIG. 15 is a block flow diagram of a process of obtaining information for locating an asset.

FIG. 16 is a timing diagram of landmark message transmissions and asset tag listen windows, including a synchronized asset tag listen window.

FIG. 17 is a block flow diagram of another process of obtaining information for locating an asset.

The figures are not shown to scale in order to facilitate illustration and understanding of the description.

### DETAILED DESCRIPTION

Techniques are provided for providing variable listen durations and/or synchronized wake-up timing of one or more asset tags. For example, multiple landmark tags may be used to send landmark messages with different timings. For example, one type of landmark tag may send landmark messages more frequently, i.e., at a higher-frequency-transmission rate, than another type of landmark tag. An asset tag may listen for different lengths of time, listening for a longer length of time less often than listening for a shorter length of time. Thus, the asset tag may hear one or more of the higher-frequency-transmission rate landmark messages during the shorter length of listen time. By varying the listen duration, the asset tag may save energy and thus extend battery life compared with listening for the longer duration every time. As another example of techniques provided, an asset tag may synchronize its listen duration with a transmission of a landmark message. The asset tag may listen for and receive a landmark message from a landmark tag during a listen duration. The asset tag may determine when that landmark tag will (e.g., next) send a landmark message, sleep until approximately that time, wake-up in time to hear the landmark message, listen for, receive, and process that landmark message. The listen duration of the asset tag when synched to a landmark message may be much shorter, e.g., approximately the length of the landmark message, and thus may reduce power consumption and extend battery life of the asset tag.

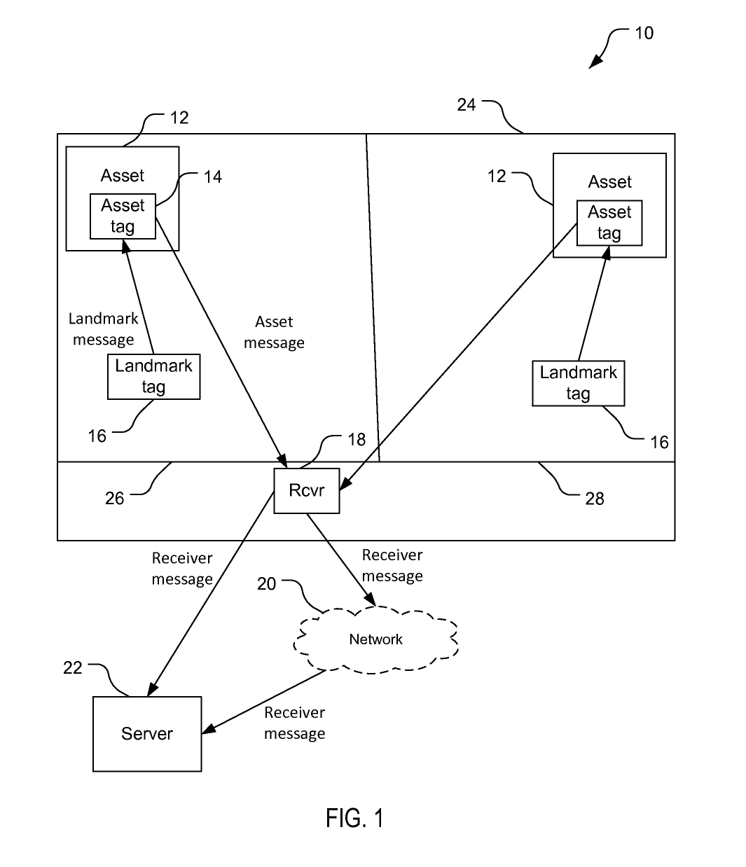

Referring to FIG. 1, an example of an asset tracking environment 10 includes assets 12 that each include an asset tag 14, landmark tags 16, a receiver 18, a network 20, a server 22, and a building 24. The building 24 includes rooms 26, 28, and the asset tags 14, the landmark tags 16, the receivers 18, the network 20, and the server 22 form an asset tracking system. While only one receiver 18 is shown in FIG. 1, and is shown outside of the rooms 26, 28, more than one receiver 18 may be used, and one or more receivers 18 may be disposed in one or both of the rooms 26, 28. Further, the asset tracking system shown in FIG. 1 may include different quantities of the asset tags 14, the landmark tags 16, the receivers 18, and/or servers 22 than shown. Additionally, while the server 22 is shown outside of the building 24 (and communicatively coupled to the remainder of the asset tracking system via a network 20 as described below), the server 22 may alternatively be located in the building 24.

The asset tags 14 can wirelessly communicate with the landmark tags 16 and the receiver 18 via antennas. The asset tags 14 can receive communications, e.g., landmark messages or other communications, from the landmark tags 16 using one or more wireless communication protocols. Example protocols include, but are not limited to, wireless personal area network (WPAN) protocols such as the Bluetooth® low-energy (BLE) wireless communication protocol. The asset tags 14 may use other short-range, low-energy wireless communication protocol, and can send communications, e.g., asset messages, to the receiver 18 using wireless communication protocol.

The landmark tags 16 are configured to transmit (broadcast) the landmark messages to the asset tags 14. The landmark tags can transmit the landmark messages using a short-range, low-energy wireless protocol, although the landmark tags 16 may also or alternatively be configured to transmit using a different protocol, e.g., the Bluetooth®, but not low-energy, wireless communication protocol.

The receiver 18 is configured to receive the communications, e.g., the asset messages, from the asset tags 14 using a short-range, low-energy wireless protocol, and to send communications to the server 22 either directly or through the network 20. The network 20 is optional such that the asset tracking system may omit the network 20 and the receivers 18 could communicate directly with the server 22. While FIG. 1 illustrates both a direct communication link from the receiver 18 to the server 22 and an indirect communication link from the receiver 18 to the server 22 via the network 20, some implementations may utilize only one of these communication links. If the receiver 18 communicates with the server 22 directly, then the network 20 may be omitted from the environment shown in FIG. 1.

The assets 12 can be moved to various locations, here being shown in the rooms 26, 28 of the building 24. The assets 12 may be moved to other locations in the building 24 or even outside of the building 24. Each of the assets 12 includes a corresponding one of the asset tags 14, e.g., affixed to the asset 12 such that the asset tag 14 stays with the asset 12 and is disposed to facilitate wireless communication with the landmark tags 16 and the receiver 18.

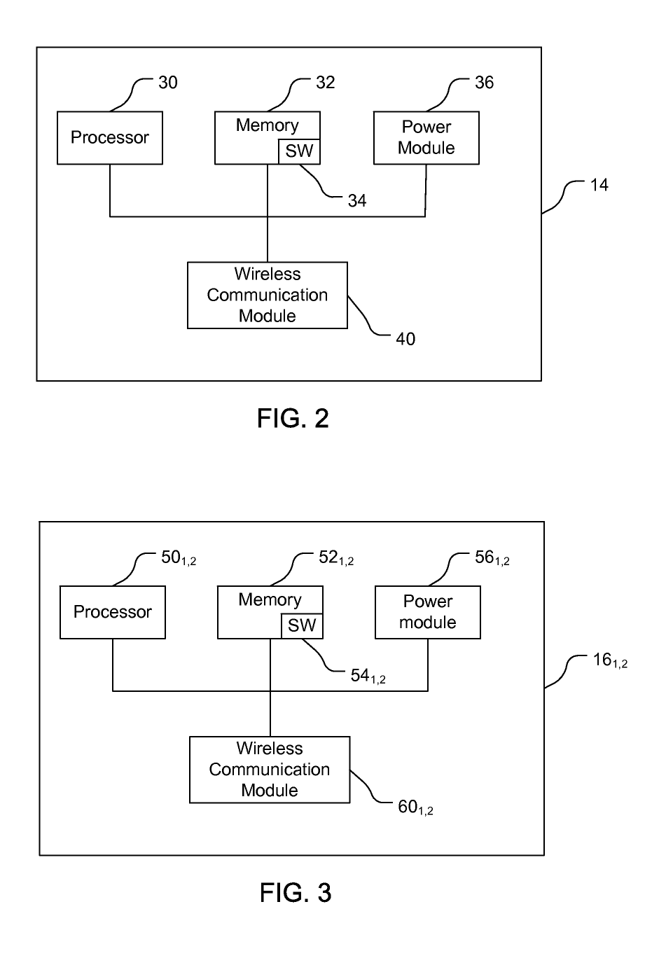

Referring to FIG. 2, an example of one of the asset tags 14 comprises a computer system including a processor 30, a memory 32 including software 34, a power module 36, and a wireless communication module 40. These components of the asset tag 14 are communicatively coupled, that is, directly and/or indirectly connected to provide information or power, as appropriate, to each other. The power module 36 may be a battery such as a coin-cell battery, although other configurations of the power module 36 may be used. The wireless communication module 40, including any appropriate transceiver is configured, including one or more appropriate antennas, to send signals to and receive signals from the landmark tags 16 (e.g., receive the landmark messages from the landmark tags 16) and/or the receiver 18 (e.g., transmit the asset message to the receiver 18). The signals to be sent are generated and formatted by the wireless communication module 40 and the received signals are interpreted by the wireless communication module 40, or wireless communication means. For example, the wireless communication module 40 is configured to generate and interpret signals in accordance with the BLE wireless communication protocol. The processor 30 is preferably an intelligent hardware device, e.g., a central processing unit (CPU) such as those made by ARM®, Intel® Corporation, or AMD®, a microcontroller, an application specific integrated circuit (ASIC), etc. The processor 30 could comprise multiple separate physical entities that can be distributed in the asset tag 14. The memory 32 is a non-transitory processor-readable storage medium that includes random access memory (RAM) and/or read-only memory (ROM). The memory 32 stores the software 34 which is processor-readable, processor-executable software code containing processor-readable instructions that are configured to, when executed, cause the processor 30 to perform various functions described herein, although the description may refer only to the processor 30 as performing a function. Alternatively, the software 34 may not be directly executable by the processor 30 but configured to cause the processor 30, e.g., when compiled and executed, to perform the functions. The processor 30, in combination with the software 34 and/or other hardware and/or firmware, may be referred to as a processor means.

The module 40 is a functional module implemented by the processor 30 and the software 34 stored in the memory 32. Thus, reference to the module 40 performing or being configured to perform a function is shorthand for the processor 30 performing or being configured to perform the function in accordance with the software 34 (and/or firmware, and/or hardware of the processor 30). Similarly, reference to the processor 30 performing a wireless communication function is equivalent to the wireless communication module 40 performing the function.

The asset tag 14 is preferably a BLE device that is fixed to the asset 12. The asset tag 14 is a small, inexpensive device (e.g., capable of being manufactured for about $5 or less). The asset tag 14 is configured to intermittently sleep and listen. The intermittent listening may be periodic (e.g., at regular, consistently-spaced intervals) or non-periodic (e.g., random, partially periodic and partially aperiodic, or another non-periodic scheme). For example, the asset tag 14 may be configured to listen four times a day by sleeping for about six hours, then waking and listening for about five seconds (or ten seconds, or another duration), then sleeping for about another six hours, etc. Other sleep and/or wake intervals, and/or other patterns of sleep and/or wake intervals may be used. Reference to the asset tag 14, or the wireless communication module 40, sleeping or waking up includes one or more portions of the asset 14 or the wireless communication module 40 sleeping or waking up, with one or more other portions of the asset tag 14 or the wireless communication module 40 not sleeping or waking up, respectively.

The processor 30 is configured to cause the wireless communication module 40 to sleep, and then wake up and listen for landmark messages. The processor 30 is configured to prepare an asset message that includes information regarding a received landmark message and to send the asset message to the receiver 18 (e.g., in a broadcast and/or directed fashion). Information in the asset message may include, but is not limited to, information regarding one or more landmark messages received in a most recent listening period.

The asset tag 14 uses less power while sleeping than when awake. For example, the asset tag 14 may use about 1 μA of current while sleeping, about 20 mA of current while listening for a landmark message, and about 10 mA of current while transmitting an asset message, which takes about 7 ms. The asset tag 14 may analyze a received landmark message from a landmark tag 16 to determine a received signal strength of the landmark message (e.g., specified by a received signal strength indication (RSSI)), and/or to determine the identity of the landmark tag 16 that sent the landmark message. The asset tag 14 may use these data to prepare the asset message such that the asset message includes the corresponding RSSI and the corresponding landmark tag identity (landmark tag ID). If landmark messages are received from multiple landmark tags 16, then the asset message will preferably include RSSIs and corresponding landmark tag IDs for the different landmark tags 16 from which the messages were received.

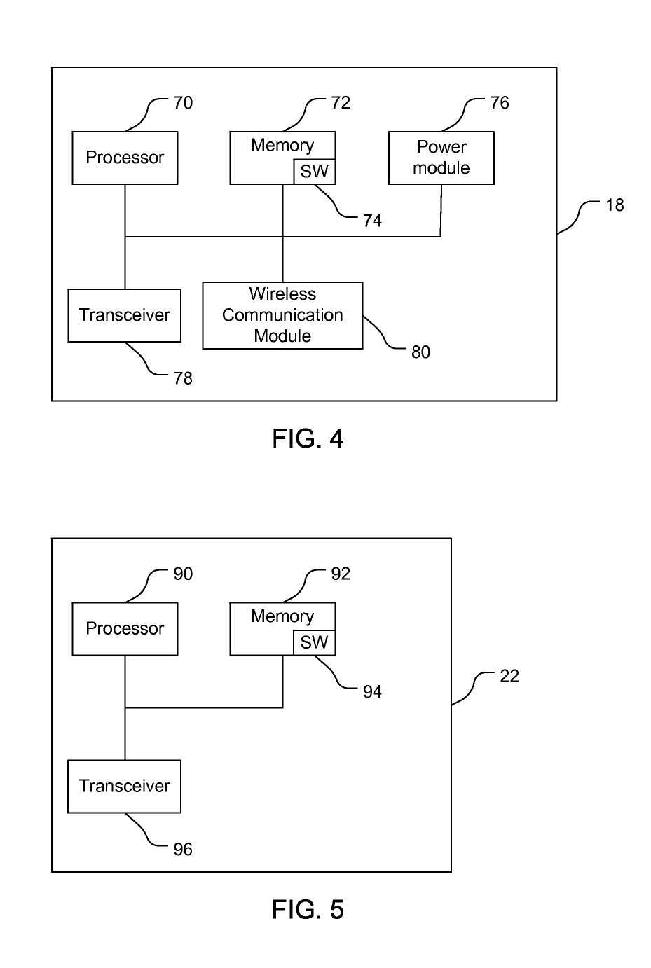

Referring to FIGS. 3-4, for the example system shown in FIG. 1, the landmark tags 16 and the receiver 18 are similarly, but not identically, configured to the asset tags 14. While the two landmark tags 16 shown in FIG. 1 may be configured similarly, FIG. 3 provides labels for multiple landmark tags 16_{1,2}, that may be configured differently (or at least operate differently) as discussed below with respect to the discussion of variable listen duration and/or synchronized wake-up of asset tags. Thus, for the discussion here of FIG. 3 and the components of the landmark tags, it is assumed that the components are similar and thus only one reference number for each component is used. The landmark tags 16 each include a processor 50, a memory 52 that stores software 54, a power module 56, and a wireless communication module 60. The receiver 18 includes a processor 70, a memory 72 that stores software 74, a power module 76, a transceiver 78, and a wireless communication module 80. The transceiver 78 is configured for wired communication while the wireless communication module 80 includes a transceiver for wireless communication. The landmark tags 16 may be inexpensive to manufacture, like the asset tags 14, e.g., for about $5 or less. The software 54, 74 will, however, be configured differently from the software 34 in order to implement the different functionality of the landmark tags 16 and the receiver 18 as discussed herein. Further, the landmark tags 16 and the receiver 18 include power modules 56, 76, respectively, that may be configured to connect to grid power (e.g., a wall outlet) in addition to, or instead of, being powered by batteries (i.e., batteries may not be used or even included in the landmark tag 16 or the receiver 18).

The wireless communication module 60 is configured to send broadcast landmark messages. The broadcast messages are not configured for or directed at a particular asset tag 14, but configured for reception and interpretation by any asset tag that is within range of the landmark tag 16. The transceiver of the wireless communication module 60 of the landmark tag 16 may be replaced with a transmitter, without receive capability.

The receiver 18 is configured to communicate with the server 22 and with the asset tags 14. The transceiver 78 of the receiver 18 includes appropriate means to communicate with, e.g., send receiver messages to and receive messages from, the server 22 either directly or through the network 20. Further, the wireless communication module 80 includes appropriate apparatus (e.g., an antenna, an interface with the processor 70, etc.) to transmit and receive wireless communication signals with the asset tags 14. Communications with the wireless communication module 80 may be implemented according to one or more wireless communication protocols such as Wi-Fi, Ethernet, power over Ethernet (PoE), cellular protocols including 3G and/or 4G, in addition to BLE or other WPAN protocol.

The landmark tag 16 is preferably a low-power wireless communication (e.g., BLE) device that has a known location. The landmark tag 16 may be fixed to a particular location, may determine its location periodically, may determine its location if moved, may be programmed with its location, etc. The landmark tag 16 is configured to send landmark messages intermittently, e.g., periodically on a regular basis, although periodic transmissions are not required. The landmark tags 16 and the asset tags 14 are configured such that a listen period (duration) of the asset tag 14 is longer than a cycle time of transmissions of landmark messages from a landmark tag 16 (i.e., the time from the beginning of one landmark message to the beginning of the next, consecutive landmark message). The landmark tag 16 may sleep between transmissions of consecutive landmark messages, with the sleep duration being less than the listen duration of the asset tag 14. The sleep duration of the landmark tag 16 may be much shorter than the listen duration of the asset tag 14, e.g., such that at least two landmark messages will be transmitted during one listen window of the asset tag 14. The listen window of the asset tag 14 is the span of time (from a start time to an end time) during which the asset tag 14 listens. The length of the listen window is the listen duration. Typically, the landmark tags 16 are disposed in areas where the assets 12 are to be tracked, and thus within range of where asset tags 14 are expected.

The receiver 18 provides an observer/central role to listen to asset messages sent by the asset tags 14. The receiver 18 is configured to process the asset messages and send (forward) data from the asset messages, in a receiver message, to the server 22. The receiver message may be sent directly to the server 22 or indirectly to server via the network 20 that forwards the receiver message to the server 22. The receiver message sent from the network 20 to the server 22 may not be identical to the receiver message sent from the receiver 18 to the network 20. For example, the header information of the different messages may be different, but the substantive data (i.e., payload) regarding the landmark message, e.g., RSSI and corresponding landmark identity, is preferably the same.

The server 22 is configured to track the asset message data sent by the receiver 18. The server 22 may use these data to determine the position of a particular asset tag 14, and thus the corresponding asset 12. To determine the asset position, the server 22 may store locations corresponding to the landmark tags 16. The server 22 may use the position information for a given asset 12 in a variety of ways, e.g., to provide a status update, to store the position for possible reference, to initiate an action such as triggering an alarm if the asset position is not permitted for the corresponding asset 12, etc.

Referring to FIG. 5, for the example system shown in FIG. 1, the server 22 comprises a computer system including a processor 90, memory 92 including software 94, and a transceiver 96. These components of the server 22 are communicatively coupled, that is, directly and/or indirectly connected to provide information or power, as appropriate, to each other. The transceiver 96 is configured to communicate with the network 20 and/or the receiver 18. The processor 90 is preferably an intelligent hardware device, e.g., a central processing unit (CPU) such as those made by ARM®, Intel® Corporation, or AMD®, a microcontroller, an application specific integrated circuit (ASIC), etc. The processor 90 could comprise multiple separate physical entities that can be distributed in the server 22. The memory 92 is a non-transitory processor-readable storage medium that includes random access memory (RAM) and read-only memory (ROM). The memory 92 stores data (e.g., in a database) and stores the software 94 which is processor-readable, processor-executable software code containing processor-readable instructions that are configured to, when executed, cause the processor 90 to perform various functions described herein, although the description may refer only to the processor 90 as performing a function. Alternatively, the software 94 may not be directly executable by the processor 90 but configured to cause the processor 90, e.g., when compiled and executed, to perform the functions.

Selective Asset Message Transmitting

The asset tag 14 may be configured to provide a “no-transmission mode” (no-TX mode) or “airplane mode” or “screen room mode” in which asset messages are not sent. Often, it is desirable to inhibit or prohibit transmissions from the asset tag 14. For example, in screen rooms where radio frequency (RF) testing is being performed, it is undesirable to have the asset tag 14 transmit an RF signal which may interfere with the testing. As another example, on an airplane, RF transmissions are prohibited to avoid interference with navigation equipment, and thus restricting the asset tag 14 from transmitting RF signals is desirable. The asset tag 14 may be configured to provide the no-TX mode automatically, e.g., as a default and/or without manual user selection. The asset tag 14 may be configured to transmit an asset message only in response to receiving a landmark message. The asset tag 14 may include a transmission means for controlling transmission of asset messages. The transmission means provide the no-TX mode and may be implemented by the processor 30, the memory 32 including the software 34, and the wireless communication module 40.

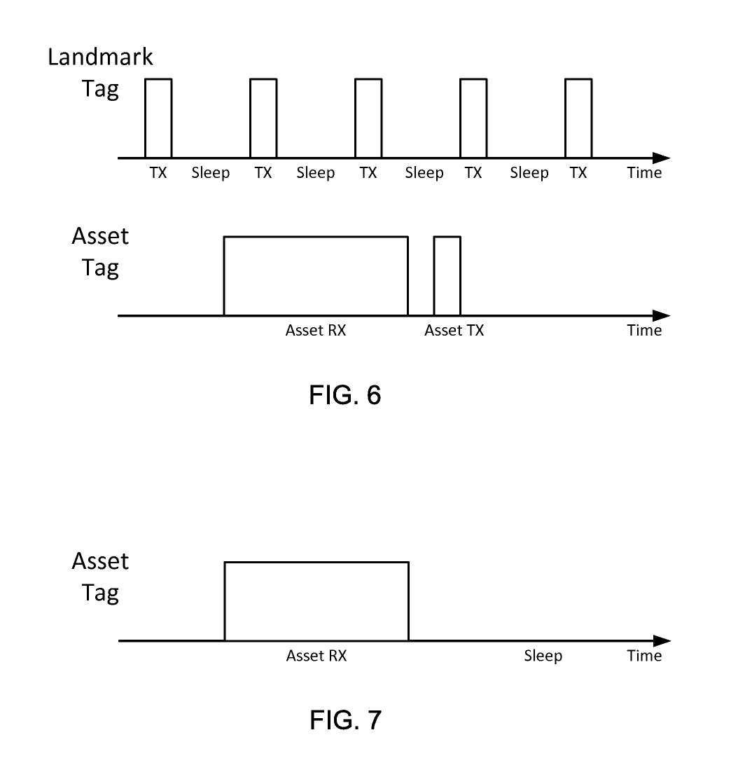

Referring to FIG. 6, after a period of sleep, the asset tag 14 wakes up and listens, i.e., analyzes received signals during an asset receive (Asset RX) period. The landmark tags 16 transmit their landmark messages at a frequency with a corresponding period that is shorter than the duration of the Asset RX period. As the asset tag 14 receives a landmark message (in this example, two landmark messages) during the Asset RX period, the asset tag 14 prepares an asset message based on at least one of the received messages, and after the end of the Asset RX period, the asset tag 14 transmits the asset message during an asset transmission (asset TX) period. The asset message may be based on only one of the landmark messages given that both landmark messages are from the same landmark tag 16. Alternatively, the asset message may be based on both of the landmark messages (e.g., including the RSSI of each of the received landmark messages, or with the RSSI in the asset message being a combination, e.g., average, of the RSSIs of the two landmark messages received during the Asset RX period).

Referring to FIG. 7, there are no landmark signals for the asset tag 14 to hear. Thus, the asset tag 14 wakes up and listens during the Asset RX, and receives no landmark messages during the Asset RX period. Consequently, the asset tag 14 neither prepares nor sends an asset message following the Asset Rx period. Thus, the asset tag 14 provides an automatic no-TX mode that can be useful for inhibiting undesired communications such as transmissions from the asset tag 14 in an undesired area such as an airplane, a screen room (e.g., a room in which wireless transmission testing is occurring where asset tag transmission could interfere with the wireless transmissions and thus impede accurate testing), where eavesdropping may occur (and information collected used without permission or even illegally), etc.

For areas where asset tag transmissions or landmark tag transmissions are undesirable, the asset tags 14 are inhibited from receiving landmark messages. For example, no landmark tags 16 are placed in, or any existing landmark tags 16 are removed from, areas of undesired asset tag transmissions. As another example, an area of undesired tag transmissions can be isolated from transmissions external to (i.e., outside of) the area from coming into the area, e.g., using radio frequency insulation (e.g., anechoic materials).

Asset Locating with Fine Resolution

Locating assets with fine granularity, e.g., less than about six feet or about two meters is challenging. Using many of the receivers 18 and selecting the location of the receiver with the strongest RSSI as the asset location is expensive due to the cost of the receivers 18. Using trilateration based on RSSIs from multiple receivers 18 using the known locations of the receivers 18 is unreliable, e.g., due to the variability in RSSI, e.g., due to multipath and interference, especially if low-energy transmissions are used to and/or from the asset tags 14.

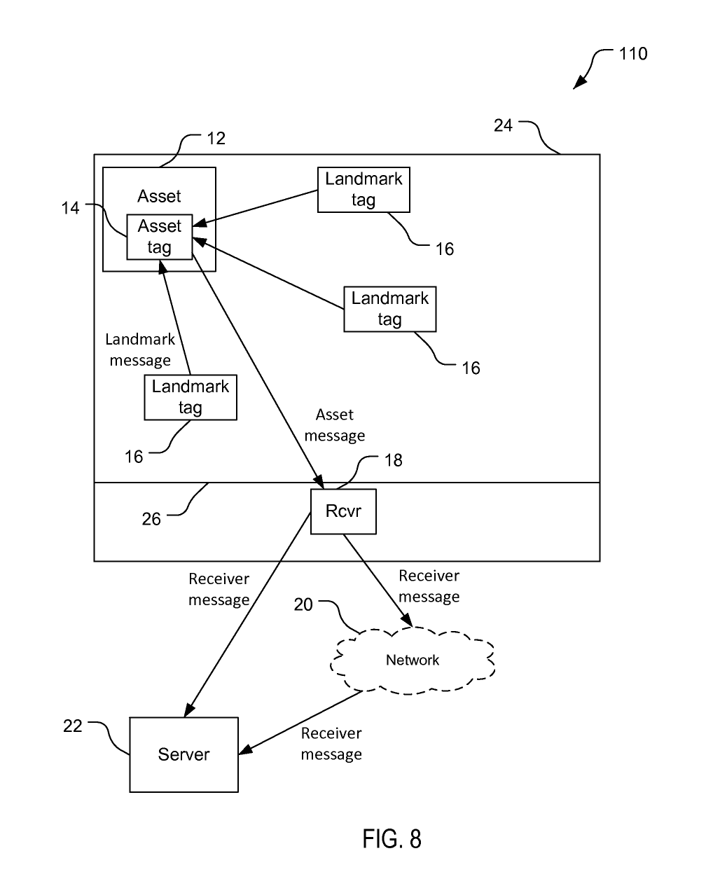

Referring to FIG. 8, an asset tracking environment 110 includes features similar to those of the environment 10 shown in FIG. 1. In the environment 110, multiple landmark tags 16, each with a known location, are disposed within communication range of the asset tag 14 using BLE signals. The landmark tags 16 are disposed such that sufficient (preferably at least three) landmark tags 16 will be in communication range of expected areas of asset location to enable trilateration to determine the asset location. Also or alternatively, an asset location may be assigned to the location of the landmark tag 16 from which a landmark message is received. Other techniques may also be used to determine a location of the asset 12. The granularity of the determined asset location may be improved by adding landmark tags 16, and the granularity may be changed over time, e.g., beginning with few landmark tags 16 and a corresponding coarse granularity and changing over time to have more landmark tags 16 and a correspondingly finer granularity.

The asset tag 14 includes asset message means for producing an asset message including information from multiple landmark tags 16. The asset message means (AMM) may be implemented by the processor 30, the memory 32 including the software 34, and the wireless communication module 40. The AMM receives landmark messages (each including a landmark ID) from the landmark tags 16, determines corresponding RSSIs, and composes an asset message that includes the landmark IDs and corresponding RSSIs. The AMM sends the asset message to the receiver 18 that forwards the asset message (or at least the substantive content of that message) to the server 22 in a receiver message. The receiver 18 may also determine an RSSI of the received asset message and provide this RSSI to the server 22.

The location of the asset 12 corresponding to the asset tag 14 is determined based on the RSSIs of the landmark messages and the corresponding locations of the landmark tags 16, and possibly the RSSI of the asset message received by the receiver 18 and the known location of the receiver 18. The locations of the landmark tags 16 may be stored or determined in conjunction with determining the asset location. The location of the asset 12 may be determined by any of a variety of apparatus, e.g., the asset tag 14 or the server 22. In this example, with the AMM sending the asset message to the receiver 18 and the receiver sending the substance of that message to the server 22 in the receiver message, the location of the asset 12 is determined by the server 22. Proximity means (including one or more proximity algorithms) in the server 22 use the known locations of the landmark tags 16 identified in the receiver message and the corresponding RSSIs to determine the asset location, e.g., by assigning the asset location as the location of the landmark tag 16 whose corresponding signal has the highest RSSI at the asset tag 14. Also or alternatively, the server 22 may determine and/or confirm the asset location using trilateration (e.g., by converting the RSSIs into distances and determining the intersections of circles with radii of these distances centered at the corresponding known landmark tag locations).

Other techniques may be used to determine the location of the asset 12. For example, the server 22 may assign the location of the landmark tag 16 with the highest corresponding RSSI in the asset message as the location of the asset 12.

Also or alternatively, a tiered approach to asset location may be provided. The server 22, or other device determining the asset location, may be configured to determine a coarse location of the asset 12. For example, the server 22 may decide, or be directed, to determine a coarse location of the asset 12. To determine the coarse location, the server 22 may assign the location of the landmark tag 16 with the highest corresponding RSSI in the asset message from among landmark tags 16 that are designated as coarse-location landmark tags 16. The server 22 may analyze only the RSSIs corresponding to landmark tags 16 that are designated as coarse-location landmark tags 16. Each landmark message may include an indication of whether the landmark tag 16 is a coarse-location landmark tag 16. More than two tiers of granularity may be provided, with the landmark tags 16 corresponding to respective tiers, and each of the landmark messages including an indication of the tier of the corresponding landmark tag 16. While a two-tiered approach has been described, and is further discussed below, configurations with more than two tiers may be used.

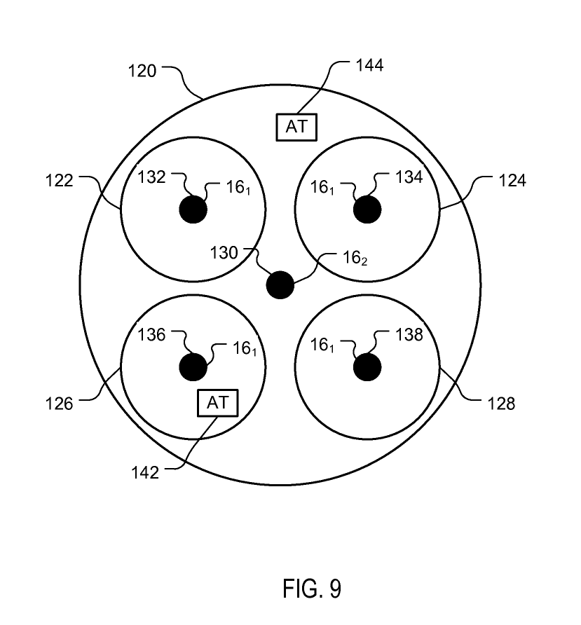

Referring to FIG. 9, an example of two-tier landmark tag coverage areas, as part of a two-tier asset tracking system, are shown. Here, a landmark tag coverage area 120 corresponds to a second-tier (or tier-two) landmark tag 130. Within the coverage area 120 are further, more granular, coverage areas 122, 124, 126, 128 corresponding to first-tier (or tier-one) landmark tags 132, 134, 136, 138, respectively. The landmark tags 130, 132, 134, 136, 138 may be operated concurrently and/or independently. In this example, the transmission power of the second-tier landmark tag 130 is stronger than the transmit powers of the first-tier landmark tags 132, 134, 136, 138, providing the larger coverage area 120 compared to the coverage areas 122, 124, 126, 128. While the coverage areas 122, 124, 126, 128 are shown not to overlap and not to cover the entire coverage area 120, the locations and/or transmit powers of the landmark tags 132, 134, 136, 138 may be such that at least some of the coverage areas 122, 124, 126, 128 overlap and cover all or nearly all of the entire coverage area 120. Further, the coverage area of one or more other second-tier landmark tags may overlap with the coverage area 120 of the landmark tag 130. The transmit power of a landmark tag may be variable or fixed. As further shown in the example of FIG. 9, an asset tag (AT) 142 is disposed in the coverage areas 120 and 126 while an asset tag 144 is disposed only in the coverage area 120.

The landmark messages and asset messages are configured to convey desired information. The landmark messages from the landmark tags 130, 132, 134, 136, 138 are preferably configured to indicate the tier of the corresponding landmark tag. The asset messages from the asset tags 142, 142 are preferably configured to indicate the landmark IDs, corresponding RSSIs, and corresponding tiers determined from the received landmark messages. This information may be used to determine the asset location, e.g., using trilateration or other means. As another example, the asset tags 142, 144 may be configured such that the asset messages indicate the landmark tag ID and corresponding tier of the signal with the highest RSSI in each tier (and may or may not include the corresponding RSSI). As yet another example, the asset messages may include only one tier's information, e.g., the landmark IDs and corresponding RSSIs for the first tier of landmark tags 132, 134, 136, 138 or for the second-tier landmark tag 130.

The asset message may not include landmark IDs for all the landmark messages received, e.g., due to limited size of the asset message. For example, if the asset message is limited to N landmark IDs, then an asset message may include N−1 first-tier landmark IDs corresponding to the first-tier landmark messages with the N−1 highest corresponding RSSIs, and one second-tier landmark ID. Preferably, asset messages with multiple landmark IDs provide the landmark IDs in order of RSSI (e.g., strongest RSSI to weakest RSSI). Alternatively, the asset tags 142, 144 may be configured such that the asset messages only indicate the landmark tag ID with a corresponding highest RSSI of a selected tier. For example, a landmark tag ID of a first-tier landmark tag may be used if first-tier, fine resolution is selected, or a landmark tag ID of a second-tier landmark tag may be used if second-tier, coarse resolution is selected.

An assigned/determined location of an asset tag 14 may depend on the (selected) resolution of the asset tag location. For example, if coarse asset location determination is used, with the asset location being assigned the location of the landmark tag with the highest corresponding RSSI, then both of the asset tags 142, 144 will be assigned the location of the coarse landmark tag 130. If fine asset location determination is used, with the asset location being assigned the location of the landmark tag with the highest corresponding RSSI and the finest tier with an available landmark message, then the asset tag 142 will be assigned the location of the landmark tag 136 while the asset tag 144 will be assigned the location of the landmark tag 130. Thus, the portion of the coverage area 120 not covered by one of the tier-one coverage areas 122, 124, 126, 128 is covered by the tier-two coverage area.

The varying granularities of asset location discussed above with respect to the environment 110 provide a variety of service and opportunities. For example, fewer receivers 18 may be used than with other systems, reducing cost of asset tracking Additionally, asset tracking on a fine scale (e.g., tracking on a scale of less than six feet) such as to uniquely identify a workstation or bench, may be provided cost effectively. Further, an indication (e.g., an alert or alarm) may be provided if an asset tag 14 receives a landmark message from an unapproved landmark tag 16 (e.g., on a disapproved list or not on an approved list). Such an alert may indicate that an asset 12 is in a location in which the asset 12 is not approved to be, or an area that may result in undesired consequences (e.g., a temperature sensitive product being located in an area of high heat).

Asset Locating Using Relay Tags

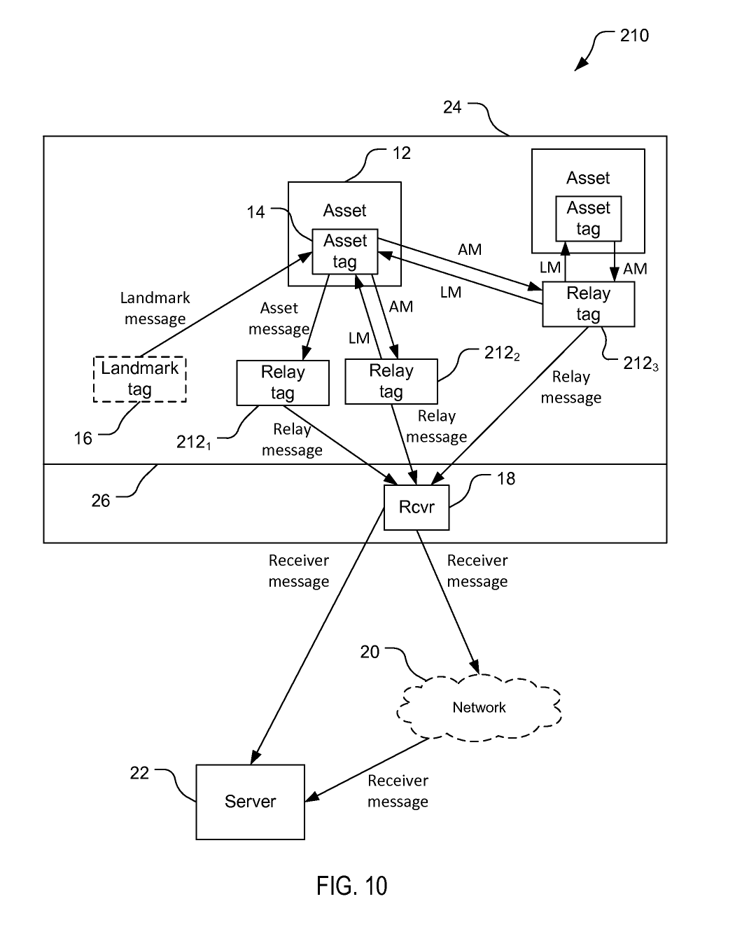

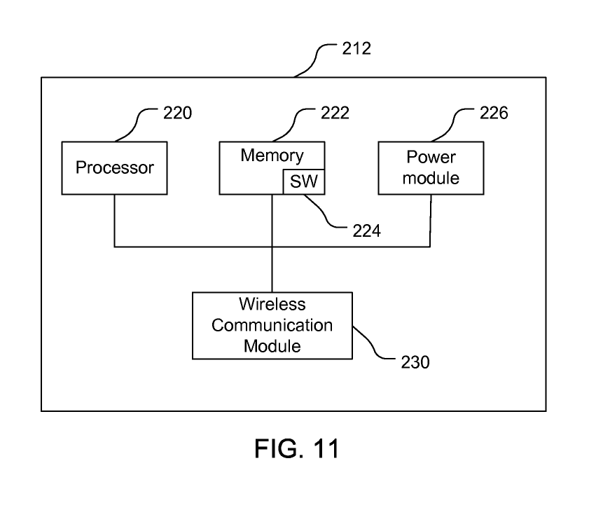

Referring to FIG. 10, an asset tracking environment 210 includes features similar to those of the environment 10 shown in FIG. 1. The environment 210, however, further includes multiple relay tags 212₁-212₃. Referring also to FIG. 11, each of the relay tags 212 include components similar to the landmark tag 16 shown in FIG. 3, including a processor 220, memory 222 that includes software 224, a power module 226, and a wireless communication module 230. The power module 226 of the relay tag 212 is preferably configured to connect to grid power and the relay tag 212 is configured to scan/listen continuously for asset messages. Few if any stand-alone landmark tags 16 may be used in the environment 210 as the landmark tags 16 are not used to obtain fine-granularity location determination. Thus, the landmark tag 16 is optional and may be eliminated.

The relay tags 212 have known locations and are placed to provide desired granularity of asset location resolution. For example, relay tags 212 may be placed one per room, or on desks, workstations/benches, etc. to provide room granularity, desk granularity, or workstation/bench granularity, respectively.

The relay tags 212 are configured to scan for asset messages, determine corresponding RSSIs of the asset messages at the relay tags 212, and forward the asset messages to the receiver 18 in relay messages. The relay messages may be reformatted, and may, in addition to the substance of the asset messages, contain RSSI information as to the RSSI of the asset messages. A single asset message can be sent from an asset tag 14 to the receiver 18 via multiple routes because the single asset message may be received and forwarded by multiple relay tags 212. Using multiple relay messages, the server 22 can determine the location of an asset 12, e.g., by assigning the location of the relay tag 212 with the strongest RSSI from the corresponding asset tag 14, and/or using trilateration and RSSI values and known relay tag (and/or landmark tag) locations, etc.

The landmark tags 16 are configured to provide an indication that the asset tag 14 responds to by eliminating or reducing future listen periods. The landmark messages from the landmark tags 16 in the environment 210 provide an indication that the environment includes relay tags 212 while landmark messages in environments without relay tags 212 do not provide this indication, and thus indicate that the environment does not have relay tags 212. The asset tag 14 is configured to analyze the landmark messages and to respond to the environment not having relay tags 212 by continuing to wake up and listen for landmark messages and to respond to the environment having relay tags 212 by either reducing the frequency of future listen periods (e.g., listening once a day instead of four times a day) or eliminating future listen periods. Further, if screen room or other location-based transmissions are not an issue, then the asset tag 14 may be configured not to listen for landmark tags.

Also or alternatively, one or more of the relay tags 212 may be configured to act as a landmark tag, sending landmark messages (LMs), in addition to relaying asset messages (AMs). In this case, stand-alone landmark tags 16 are preferably not used. The relay/landmark tag(s) 212 will send the landmark messages, including indications that the environment 210 includes relay tags 212.

Using the environment 210 may provide desirable features. For example, battery life of the asset tag 14 may be increased compared to environments where the asset tag 14 would listen more often than in the environment 110. Reducing the number of receive periods, or eliminating receive periods, can increase battery life of the asset tag 14. Also, even when landmark tags 16 are used, the asset tag 14 does not need to hear landmark messages from multiple landmark tags 16, but just one landmark message indicating that relay tags 212 are present, and thus the receive period may be shorter than in other environments, further reducing battery drain and increasing battery life. Further, reducing/eliminating landmark messages reduces radio frequency (RF) transmissions in the environment 210 compared to environments with more landmark tags. In the environment 210, for example, instead of landmark messages being sent frequently by multiple landmark tags, landmark messages may not exist and only infrequent (e.g., four times daily) asset messages are sent by each of the asset tags 12, which are forwarded by the relay tags 212 in the relay messages. Also, transmissions by the asset tags 14 may be scheduled such that interference is reduced, e.g., with asset tag transmissions scheduled to occur during times when other transmissions are not occurring. Further, asset tag transmission power may be reduced compared to environments without relay tags 212 because the asset messages do not need to reach the receiver 18. For similar reasons, the range of the environment 110 (i.e., the area over which asset tags 14 may communicate with the receiver 18) may be greater than in environments without relay tags 212. With landmark tags 16 being used, screen room functionality as discussed above may be provided.

Fine-Granularity Information Dissemination

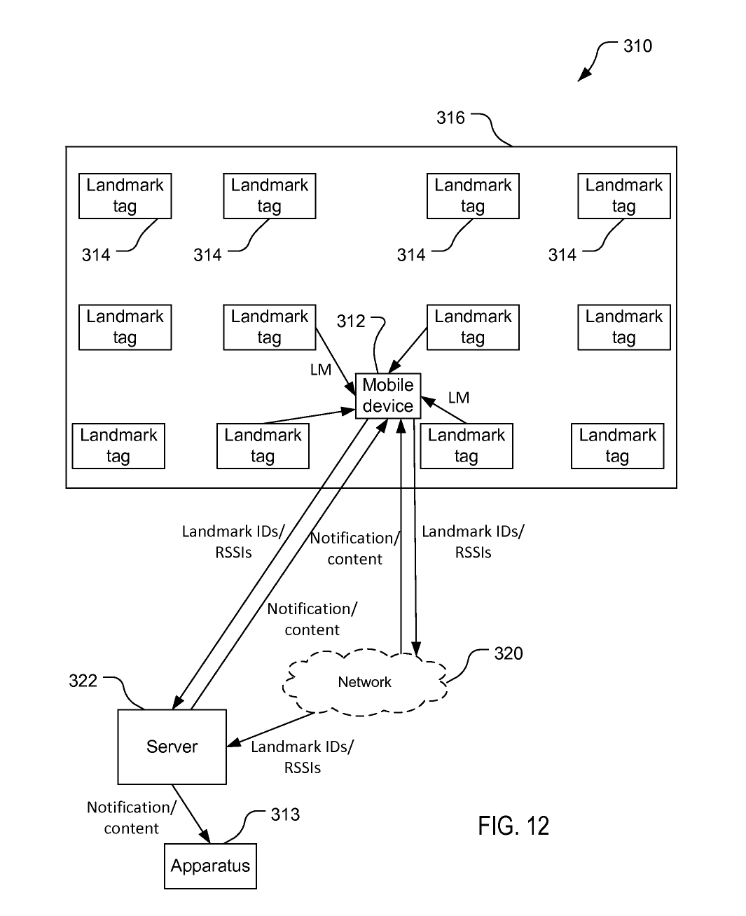

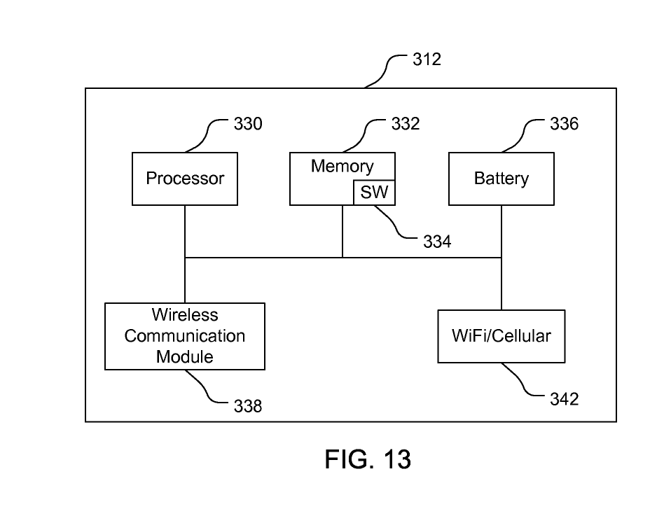

Referring to FIG. 12, an information dissemination system 310 includes a mobile device 312, landmark tags 314 disposed in a building 316, a network 320, and a server 322. The number of landmark tags 314 used (in this example, 12), and where the landmark tags 314 are disposed, are selected to provide desired location resolution. The landmark tags 314 may include components similar to the landmark tags 16 shown in FIGS. 1 and 3, and the server 322 may include components similar to the server 22 shown in FIGS. 1 and 5. As with the landmark tags 16, the landmark tags 314 may use Bluetooth® Low-Energy protocol, and/or another short-range, low-power protocol. The transmission power of the landmark tags 314 can be adjusted to provide desired range(s). Referring also to FIG. 13, the mobile device 312 includes a processor 330, memory 332 including software 334, a battery 336, a wireless communication module 338, and a WiFi/Cellular module 342. The WiFi/Cellular module 342 includes any appropriate transceiver and is configured to communicate using WiFi and cellular (e.g., 3G, 4G, etc.) protocols with access points (not shown), the optional network 320, and the server 322.

The mobile device 312 is configured to collect and forward landmark tag information. The mobile device 312 can scan for the landmark messages (LMs) from the landmark tags 314. The mobile device 312 can forward/send landmark identities (landmark IDs) and corresponding RSSIs to the server 22. The server 22 uses stored locations of the landmark tags corresponding to the noted landmark IDs, and the corresponding RSSIs to determine a location of the mobile device 312. In response to determining the mobile device's location, the server 22 sends appropriate notification(s)/content for that location to the mobile device 312 in accordance with any preference(s) and/or permission(s) associated with the mobile device 312. For example, a user of the mobile device 312 may have to request and/or be granted access/permission for some information and/or the user of the mobile device 312 may block certain information.

Content can be published/pushed to the server 22 in a variety of ways. A first way to publish/push content is to have a user of the mobile device 312 use an application to generate content and deliver the content to the server 322. The mobile device 312 also provides landmark IDs and corresponding RSSIs to the server 322. The server 322 determines the location of the mobile device 312 and adds content (e.g., a notification) for the determined location. A second way to publish/push content is to have a user interact with an application (e.g., a web site accessed by the user through a web interface) to produce the content.

The server 22 is configured to provide content to appropriate devices based on location associated with the content. The server 22 sends content corresponding to a location to devices associated with the location, e.g., to devices disposed in that location and/or that have requested content related to that location.

The system 310 can provide location-aware content. A user of the mobile device 312 or another apparatus 313 may request (e.g., subscribe to) information related to a particular region. In response to content being produced for the particular region, the server 322 sends the content to the mobile device 312 or the apparatus 313. The request for information related to a region may take a variety of forms, e.g., the user interacting with an application to select an option to receive such information, or automatically by the mobile device 312 being disposed in the region, etc. Thus, the present location of the mobile device 312 and/or any subscription setting may play a role in whether the mobile device 312 and/or the apparatus 313 is sent the content. For example, a user of the apparatus 313 may request to receive notifications for the region of the mobile device 312 regardless of the present location of the apparatus 313, the user of the mobile device 312 may request to receive the content for the region when the mobile device 312 is proximate to (e.g., in the same building as, within N meters of) the region, and/or when the mobile device 312 is in the region. The content may be sent to the mobile device 312 or the apparatus 313 in a variety of ways, e.g., email, SMS, IM, etc. The granularity of location related to content (for generated content and/or pushed content) may be very fine and is a function of the granularity of placement of landmark tags 314 and/or resolution capable using the landmark tags 314 (e.g., based on landmark tag transmit power, etc.).

The system 310 can provide real-time, location-aware content notification. The system 310 can provide information in a cost-efficient many, with fine-granular position resolution, and in an easy-to-deploy manner.

Applications of location-based content delivery using the system 310 are endless. For example, location-based social media may be enabled such that, e.g., social media content may be shared only with mobile devices in proximity to the mobile device providing the content. Notices can be provided regarding malfunctioning or inoperable devices (e.g., to workers near a copier may be notified that the copier is out of order, or to persons near a break room may be notified that the coffee machine in that break room is empty or not working) Notices can be provided with respect to time-critical information (e.g., workers near a conference room may be notified that free food is available in the conference room). As another example, a list of equipment assigned to a workstation may be provided to a mobile device near that workstation, and/or lists of equipment assigned to each workstation in a room may be provided to a requesting mobile device in the room. As a further example, a description of an object of interest (e.g., a piece of art, a museum exhibit) may be provided to each mobile device proximate to the object of interest. Still further, information regarding a region, e.g., malfunctioning equipment, may be provided to a device outside that region, e.g., to a maintenance technician assigned to the region.

Variable Listen Duration and/or Synchronized Wake-Up of Asset Tag

Referring to FIGS. 1, 3, and 9, one or more of the asset tags 14 may use variable listening durations and/or may have synchronized wake-up times (and thus listen windows) in environments where different landmark tags 16 operate differently. In either case, battery consumption may be reduced. Using variable listening durations may allow longer sleep durations for landmark tags 16 and/or shorter average listening durations in the asset tags 14. Having synchronized wake-up times of the asset tags 14 may allow a shorter listening duration in an asset tag 14, e.g., when the associated asset 12 has not been moved.

The first-tier landmark tags 132, 134, 136, 138 each have the components shown in FIG. 3 for the landmark tag 16₁, and the second-tier landmark tag 130 has the components shown in FIG. 3 for the landmark tag 16₂. The landmark tags 16₁, 16₂ are configured to operate differently, e.g., by having different configurations or by having similar configurations capable of different operations, with the first-tier landmark tags 132, 134, 136, 138 selected to operate one way and the landmark tag 138 selected to operate a different way. For example, at least the software 54₁ for the first-tier landmark tags 132, 134, 136, 138 may be different than the software 54₂ for the second-tier landmark tag 130. Alternatively, at least different portions of the software 54_{1,2} may be used (e.g., the software 54_{1,2} may be the same for all of the landmark tags 130, 132, 134, 136, 138 but different portions selected/used depending on whether the landmark tag is a first-tier landmark tag or a second-tier landmark tag). That is, the landmark tags 130, 132, 134, 136, 138 may be configured to operate in one of multiple, here two, modes corresponding to whether the landmark tag is a first-tier landmark tag or a second-tier landmark tag. For the discussion below, the landmark tags 16_{1,2} are referred to as being configured one way or the other, but the different configurations may be implemented by selecting/using different portions of similar software and/or other components of the respective landmark tags 16_{1,2}. Further, the discussion below is for the example situation shown in FIG. 9 where there are four first-tier landmark tags 16₁, namely the landmark tags 132, 134, 136, 138, and one second-tier landmark tag 16₂, namely the landmark tag 130.

The first-tier landmark tags 16₁ and the second-tier landmark tag 16₂ are configured to transmit their respective landmark tags with different transmit powers. The power module 56₂ of the second-tier landmark tag 16₂ is configured to transmit the landmark messages for the landmark tag 16₂ with a higher transmit power than power modules 56₁ of the first-tier landmark tags 16₂ are configured to transmit the landmark messages for the landmark tags 16₁. Thus, the coverage area 120 of the second-tier landmark tag 16₂ is larger than the coverage areas 122, 124, 126, 128 of the first-tier landmark tags 16ₖ, and the second-tier landmark tag 16₂ is typically associated with a larger area than the landmark tags 16₁. For example, the second-tier landmark tag 16₂ may be associated with a large manufacturing room and the first-tier landmark tags 16₁ may be associated with respective workstations in the room.

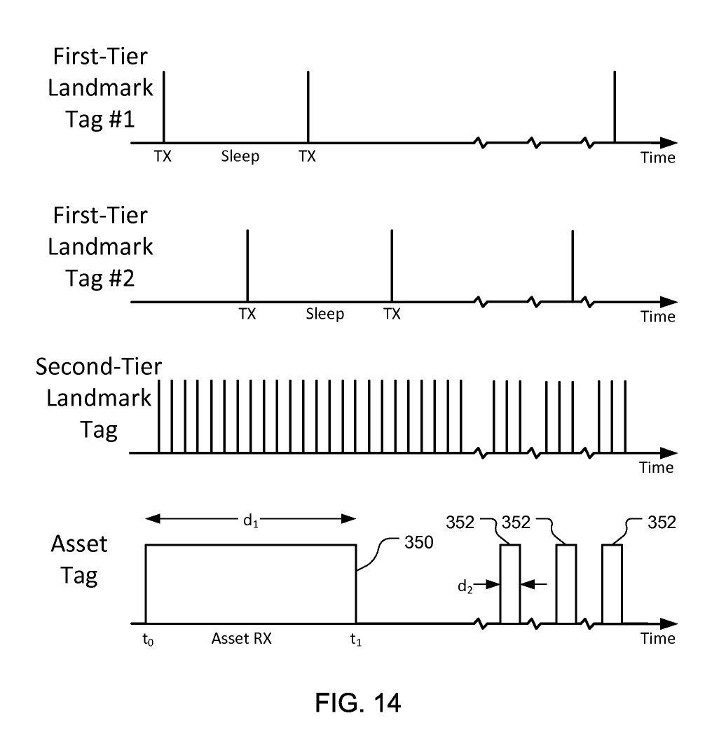

Referring also to FIG. 14, the first-tier landmark tags 16₁ and the second-tier landmark tag 16₂ are further configured to transmit their respective landmark messages with different landmark message transmission frequencies. Preferably, the landmark tags 16 are configured such that the respective transmission frequencies are constant (with constant corresponding periods), but either or both transmission frequencies could vary (with a variance in the corresponding period(s)). The second-tier landmark tag 16₂ is configured to transmit its landmark messages with a higher transmit frequency than the first-tier landmark tags 16₂ are configured to transmit their landmark messages. Thus, the second-tier landmark tag 16₂ transmits its landmark message more often than the first-tier landmark tags 16₁ transmit their landmark messages. The second-tier landmark tag 16₂ has a different (shorter) sleep duration than the first-tier landmark tags 16₁. For example, the second-tier landmark tag 16₂ may have a landmark message transmission frequency of about 1 Hz, and thus a sleep duration of about one second (e.g., one second minus the time for transmitting the landmark message, e.g., about 7 ms). The transmission cycle time (i.e., time from beginning transmission of the landmark tag to the beginning of transmission of the next landmark tag) of the second-tier landmark tag 16₂ is about one second. Further, the first-tier landmark tags 16₁ may have landmark message transmission frequencies of about 0.1 Hz (with transmission cycle times of about 10 seconds), and thus sleep durations of about 10 seconds (e.g., 10 seconds minus the time for transmitting the landmark message, e.g., about 7 ms). The landmark tags 16 may not (as shown) be synchronized with each other (neither the first-tier landmark tags 16₁ with each other, nor the second-tier landmark tags 16₂ with each other, nor any of the first-tier landmark tags 16₁ with any of the second-tier landmark tags 16₂), although two or more of the landmark tags 16 could be synchronized.

With higher landmark message transmission power and higher landmark message transmission frequency than the first-tier landmark tags 16₁, the landmark tag 16₂ is preferably powered by having the power module 56₂ connected to utility power, e.g., a wall outlet. The first-tier landmark tags 16₁ may be powered by having their power modules 56₁ connected to utility power, or by one or more respective batteries, or by battery power when utility power is unavailable and utility power when utility power is available.

The listen durations of the asset tags 14 are preferably longer than the transmission cycles of the landmark tags 16 that are desired to use for locating the asset tags 14. For example, with the transmission cycle time of the landmark tag 16₂ being about one second, and the transmission cycle time of the landmark tags 16₁ being about 10 seconds, the listen duration of each the asset tags 14 would typically be at least 10 seconds to use the first- and second-tier landmark tags 16₁, 16₂ to locate the asset tags 14. The asset tags 14 are configured to sleep (not listen) between listen windows, e.g., to conserve battery power.

Variable Listen Duration

One or more of the asset tags 14 may be configured to vary their listen durations. The asset tags 14 are configured to listen for at least two different listen durations, but could be configured to listen for more than two different durations, over different listen windows. The listen windows are the spans of time, from a start time to an end time (e.g., from t₀ to t₁ in FIG. 14), during which the asset tag 14 listens, and the listen duration is the time difference from the start time to the end time (e.g., t₁−t₀). The different listen durations may be preset or determined ad hoc. As an example, the asset tags 14 may listen for two different listen durations, sometimes using a first listen duration d₁ of first listen windows 350 (only one shown in FIG. 14) and sometimes using a second listen duration d₂ of second listen windows 352. The listen durations d₁, d₂ are preferably, though not necessarily, consistent. The first listen duration is longer than the transmission cycle time of the first-tier landmark tags 16₁ and the second listen duration is longer than the transmission cycle time of the second-tier landmark tags 16₂ but less than the transmission cycle time of the first-tier landmark tags 16₁. Preferably, the first listen duration is about 1.5 times the transmission cycle time (i.e., period) of the first-tier landmark tags 16₁ to help ensure that at least one landmark transmission is received from each first-tier landmark tag 16₁ during each first listen window 350. Preferably, the second listen duration is between about two and about three times as long as the transmission cycle time (i.e., period) of the second-tier landmark tag 16₂ to help ensure that at least one landmark transmission is received from each second-tier landmark tag 16₂ during each second listen window 352. For example, the first listen duration may be about 15 seconds and the second listen duration may be about 2-3 seconds for transmission cycle times of about 10 seconds and about one second for the first- and second-tier landmark tags 16₁, 16₂, respectively. The asset tag 14 may receive one or more landmark messages from one or more of the first-tier landmark tags 16₁, or may not receive any landmark messages from one or more of the first-tier landmark tags 16ₖ, during a second listen window 352. Any of the asset tags 14 may be configured to listen for the full first listen duration and/or the full second listen duration (or any other listen duration) regardless of what signals are received during the respective listen windows.

Referring also to FIG. 2, the wireless communication module 40 is configured to listen for the first and second listen durations intermittently. For example, the wireless communication module 40 may listen for landmark messages for the first listen duration d₁ less frequently than for the second listen duration d₂, at least some times listening for landmark messages for the second listen duration multiple times between consecutive instances of listening for the first listen duration. For example, the wireless communication module 40 may listen for landmark messages for the first listen duration once per 24-hour period and listen for landmark messages for the second listen duration three times per 24-hour period, e.g., spaced evenly between consecutive instances of listening for the first listen duration. This example is shown in FIG. 14, with the asset tag 14 configured to listen during the first listen window 350, of duration d₁, and to listen during three second listen windows 352, each of duration d₂, with the next first listen window (not shown) being 24 hours after the first listen window 350 shown.

The assets tags 14 may report different location granularity for different listen durations. The location of the respective asset tag 14 may be determined with fine granularity corresponding to the longer, first listen duration as the asset tag 14 will receive landmark messages from all landmark tags 16₁, 16₂ within range of the asset tag 14. Thus, the asset tag 14 may use multiple landmark messages to determine the location of the asset tag 14, or may provide information regarding the received landmark messages from which the location of the asset tag 14 may be determined. The location of the respective asset tag 14 may be determined with coarse granularity corresponding to the shorter, second listen duration as the asset tag 14 will receive one or more landmark messages from the second-tier landmark tag 16₂. During the second listen window, the asset tag 14 may or may not receive a landmark message from any first-tier landmark tag 16₁ within range of the asset tag 14 depending on the relative timing of the second listen window and the landmark message transmission by the respective first-tier landmark tag 16ₖ. The location of the asset tag 14 based on information obtained during the second listen duration may, for example, be assigned the location of the second-tier landmark tag 16₂, a location corresponding to a signal strength of the landmark message received from the landmark tag 16₂ and the location of the landmark tag 16₂, or another location. For example, the asset tag 14, e.g., the processor 30, and/or another entity (e.g., the server 18) that determines the location of the asset 14 may assign the last fine-granularity location as the present location if the asset tag 14 is still closest to the same second-tier landmark tag 16₂ as the asset tag 14 was as of the last fine-granularity location determination.

Any of the asset tags 14 may be configured to change from listening for the first duration to listening to the second duration. For example, the wireless communication module 40 may be configured to begin to listen for the first listen duration and change to listening for the second listen duration in response to receiving a landmark message from a second-tier landmark tag 16₂ from which a landmark message was not previously received or at least not received in a most-recent instance of listening for the first listen duration (i.e., the most-recent first listen window). The latter case would indicate that the asset tag 14 has been moved a significant distance since the last instance of listening for the first listen duration (the last first listen window).

Also or alternatively, any of the asset tags 14 may be configured to stop listening before expiration of the full first listen duration and/or the full second listen duration. For example, during a second listen window, in response to the wireless communication module 40 determining that the asset tag 14 has not significantly moved, e.g., if the module 40 receives a landmark message from the same second-tier landmark tag 16₂ from which a landmark message was received during a most recent listen window (be it a first listen window or a second listen window), the module 40 may stop the second listen window early. Also or alternatively, during a first listen window, in response to the wireless communication module 40 determining a location of the asset tag 14 and/or that the asset tag 14 has not significantly moved, e.g., if the module 40 receives landmark messages from the same first- and second-tier landmark tags 16₁, 16₂ from which landmark messages were received during a most recent first listen window, and no landmark message has been received from a different second-tier landmark tag since then, the module 40 may stop the first listen window early.

The asset tag 14 may be configured to limit listening time. For example, the wireless communication module 40 may limit total cumulative listen time, the listen time within a window of time (e.g., a day, a week, a month, or other span of time), the long-listen-time frequency (i.e., the quantity of first listen windows within a time span, such as no more than two first listen windows in a 24-hour period), etc. The wireless communication module 40 may limit the listen time based on one or more parameters such as remaining battery power and/or time, an allowable battery budget (e.g., a 220 mAh coin-cell battery), etc.

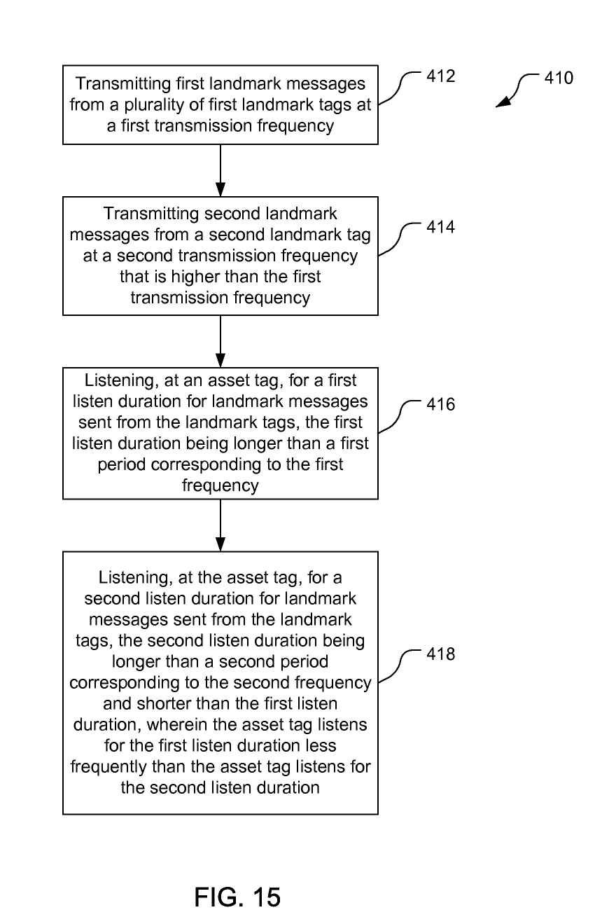

Referring also to FIG. 15, with further reference to FIGS. 1-3, 9, and 14, a process 410 of obtaining information for locating an asset includes the stages shown. The process 410 is, however, an example only and not limiting. The process 410 can be altered, e.g., by having stages added, removed, rearranged, combined, performed concurrently, and/or having single stages split into multiple stages. The process 410 may have asset tag listen windows that are asynchronous with respect to landmark message transmissions or, as discussed below, may have at least some of the asset tag listen windows synchronized to landmark message transmissions of at least one of the landmark tags 16. For the discussion of the process 410, only one asset tag 14 and only one second-tier landmark tag 16₂ are discussed, but more than one second-tier landmark tag 16₂ could be used and have their respective landmark messages received by one or more asset tags 14, and/or more than one asset tag 14 may receive landmark messages from a single second-tier landmark tag 16₂.

At stage 412, the process 410 includes transmitting first landmark messages from a plurality of first landmark tags at a first transmission frequency. The wireless communication modules 60₁ of the first-tier landmark tags 16₁ transmit their respective landmark messages via respective transceivers. These transmissions are not typically, but could be, synchronized with each other. The landmark messages are sent intermittently, preferably with a constant frequency, and thus a constant period, but possibly with a varying frequency (and varying period) such that the first frequency may be an average frequency.

At stage 414, the process 410 includes transmitting second landmark messages from a second landmark tag at a second transmission frequency that is higher than the first transmission frequency. The wireless communication module 60₂ of the second-tier landmark tag 16₂ transmits its landmark messages via its transceiver. The second-tier landmark messages are sent intermittently, preferably with a constant frequency, and thus a constant period, but possibly with a varying frequency (and varying period) such that the second frequency may be an average frequency.

At stage 416, the process 410 includes listening, at an asset tag, for a first listen duration for landmark messages sent from the landmark tags, the first listen duration being longer than a first period corresponding to the first frequency. For example, the wireless communication module 40 of the asset tag 14 listens for the first duration d₁ over the window 350 for landmark messages from the first- and second-tier landmark tags 16₁, 16₂.

At stage 418, the process 410 includes listening, at the asset tag, for a second listen duration for landmark messages sent from the landmark tags, the second listen duration being longer than a second period corresponding to the second frequency and shorter than the first listen duration, wherein the asset tag listens for the first listen duration less frequently than the asset tag listens for the second listen duration. For example, the wireless communication module 40 of the asset tag 14 listens for the second duration d₂ over the windows 352 for landmark messages from the first- and second-tier landmark tags 16₁, 16₂. Listening over the windows 352 of the second duration d₂ are repeated more often than listening over the windows 350 of the first duration d₁. By doing so, the asset tag 14 may use less power, e.g., battery power, compared to listening for the first duration d₁ during each window of listening. The landmark messages received may be used in determining a location of the asset tag 14, e.g., determined RSSI used in trilateration calculation, previously-determined location used as the present location if a second-tier landmark tag is received from the same second-tier landmark tag 16₂ from which a location message received during a most-recent listen window, etc.

Synchronized Wake-Up of Asset Tag

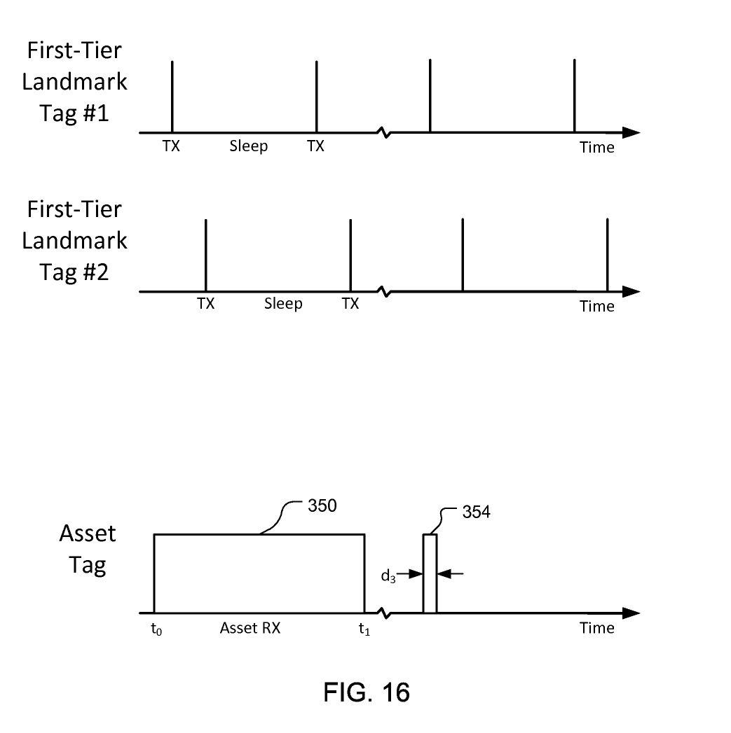

Referring to FIGS. 1-3, 9, and 16, one or more of the asset tags 14 may be configured to synchronize its listen windows to one or more landmark transmission windows from one or more of the landmark tags 16. For example, the asset tag 14 may be configured to determine with which landmark tag 16 to synchronize. The asset tag 14, in particular the wireless communication module 40, may further be configured to determine a subsequent landmark message transmission timing for the landmark tag 16 with which the asset tag 14 determines to synchronize, sleep until approximately the time of the subsequent landmark message transmission, wake up approximately at the beginning of that landmark message transmission, and listen for landmark messages. While it may technically be more accurate to say that the asset tag 14 determines the landmark message reception timing for the landmark tag with which the asset tag 14 is to synchronize, because the timing difference is negligible, these are assumed herein to be the same timing and thus the landmark message transmission timing is used for ease of understanding. Further, only one of the asset tags 14 is discussed here for further ease of understanding.

The asset tag 14 may determine with which landmark tag 16 to synchronize (referred to as the synched landmark tag 16ₛ) based on received landmark messages. For example, the wireless communication module 40 is configured to cause the asset tag 14 to listen for the long listen duration d₁ over the listen window 350, during which landmark messages from multiple landmark tags 16, including from multiple first-tier landmark tags 16₁, may be received. The processor 30 is configured (e.g., in accordance with the software 34) to determine (select) as the synched landmark tag 16ₛ the first-tier landmark tag 16₁ from which is received the landmark message with a highest RSSI. The RSSI may be determined from one landmark message from a particular landmark tag 16, or from multiple landmark messages from a particular landmark tag 16 such as by averaging the RSSI of the multiple received landmark messages. As an alternative to synching with a first-tier landmark tag 16₁, the asset tag 14 could determine to synch with a second-tier landmark tag 16₂. The discussion below, however, assumes the example where the asset tag 14 synchs to a first-tier landmark tag 16₁.

The processor 30 may determine the timing of one or more subsequent (future) landmark message transmission times of the synched landmark tag 16ₛ. For example, the wireless communication module 40 may analyze the landmark message from the synched landmark tag 16, for one or more indications of one or more subsequent landmark message transmission times (e.g., a landmark message frequency and/or period, times of day of transmissions, etc.). As another example, the frequency of the first-tier landmark message transmissions may be known (e.g., stored in the memory 32) by the asset tag 14. The processor 30 may determine subsequent transmission timing of the synched landmark tag 16, based on the landmark message transmission period and a time of arrival of the received landmark message from the synched landmark tag 16ₛ.

The asset tag 14 is configured to sleep until approximately the beginning (i.e., the synched transmission time) of a subsequent, e.g., the next, landmark message transmission (i.e., the synched landmark message) by the synched landmark tag 16ₛ, wake up at approximately this time, and listen for landmark messages for a synched listen duration d₃ over a synched listen window 354. The asset tag 14 sets, e.g., stores in the memory 32, its sleep period such that the asset tag 14 will wake up at a desired time for receiving the synched landmark message. The asset tag 14 abstains from listening for landmark messages while asleep. The asset tag 14, in particular the wireless communication module 40, wakes up sufficiently before the synched transmission time such that the asset tag 14 will hear the beginning of the synched landmark message. That is, the synched listen window 354 begins before the synched transmission time, but preferably before the synched transmission time by less than the period of the landmark message transmissions of the synched landmark tag 16ₛ. The asset tag 14, however, wakes up close enough in time to the synched transmission time that the synched landmark message will be completely received before the synched listen window 354 ends (i.e., the asset tag 14 will listen during an entire transmission window of the synched landmark message).

The synched listen duration d₃ may be variable or consistent. For example, the synched listen duration d₃ may be terminated upon the completion of receipt of the synched landmark message, or upon the expiration of a timeout period without the synched landmark message being received or beginning to be received. Alternatively, the synched listen duration d₃ may be fixed, for example about the length of the synched landmark message (e.g., the length of the synched landmark message plus some extra time to ensure capture of the entire synched landmark message). The synched listen duration d₃ is preferably much shorter than the first listen duration d₁, may be shorter than the second listen duration d₂ discussed above, and may be shorter than the period of the landmark message transmission frequency of the second-tier landmark tag 16₂. As examples of the synched listen duration being about the duration of the synched landmark message, the synched listen duration may be about 105%, about 110%, about 115%, about 120%, or about 140% of the duration of the synched landmark message, or other duration. Using these examples, for a synched landmark message duration of 7 ms, the synched listen duration d₃ may be about 7.35 ms, about 7.7 ms, about 8.05 ms, about 8.4 ms, or about 9.8 ms (e.g., 10 ms).

The asset tag 14 may listen for the synched listen duration (which may vary) synched with the synched landmark messages for various quantities of listen windows. For example, the asset tag 14 may be configured to continue listening for the synched listen duration d₃ indefinitely until a trigger even occurs to cause the asset tag 14 to listen for a different listen duration. In response to a trigger condition occurring, the asset tag 14 may change from listening for the synched listen duration d₃ to listening for the first duration d₁, or another duration (preferably longer than the synched listen duration d₃). An example of such a trigger condition is that the asset tag 14 does not receive the synched landmark message during the synched listen window 354. In response to not receiving the synched landmark message during the synched listen window 354, the asset tag 14 may listen for a different duration, such as a longer duration such as the long, first listen duration d₁. Another example of a trigger condition is that the RSSI of the synched landmark message changes significantly relative to the RSSI of a previously-received synched landmark message (e.g., received during the most-recent first listen window 350, received during the most-recent synched listen window 354, etc.). A significant change may be, for example, a change in RSSI indicating movement of the asset tag 14 of more than a threshold distance, where the threshold distance may be dependent upon an application (e.g., two meters in a manufacturing facility, 10 meters in an inventory application, etc.). As another example, a significant change may be a magnitude reduction, e.g., a 5 dB, 10 dB, or dB reduction. Another trigger condition may be that the RSSI of a landmark signal received during the second listen window exceeds the RSSI of the synched landmark signal received during that second listen window. This condition may indicate that the asset 12 has moved, is about the same distance as the asset 12 previously was from the synched landmark tag 16, but is now closer to another landmark tag 16 whose location may be a better approximation for the location of the asset 12.

The location of the asset tag 14, and thus the asset 12, may thus be determined with fine granularity while using a short listen duration, e.g., less than a period of the landmark message transmissions of the first-tier landmark tags 16₁. The last fine-granularity location of the asset tag 14 may be used as the present location of the asset tag 14 in response to the synched landmark message being received during the synched listen duration. Preferably, though not necessarily, the last fine-granularity location of the asset tag 14 is used as the present location of the asset tag 14 only in response to the RSSI of the received landmark message being substantially the same as (e.g., not significantly different than) the RSSI of a previously-received synched landmark message.

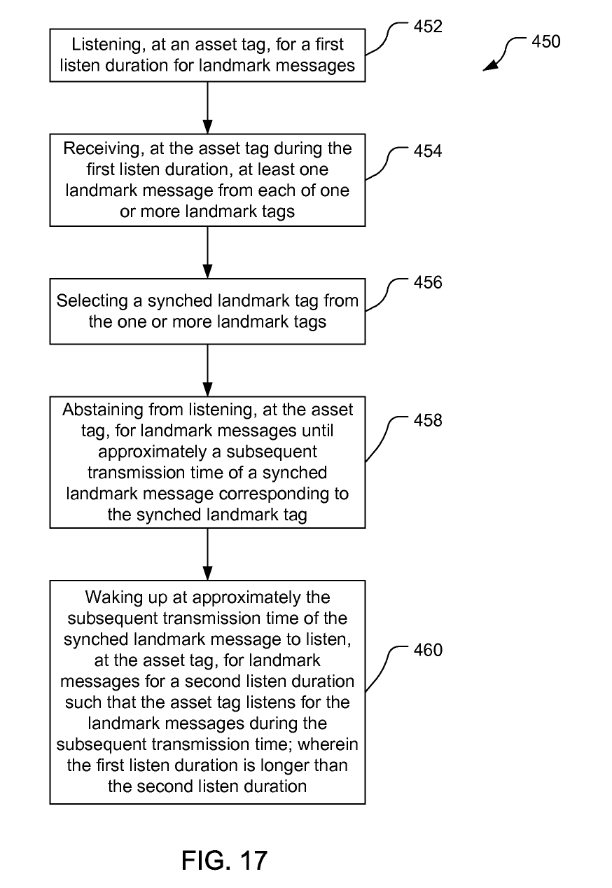

Referring to FIG. 17, with further reference to FIGS. 1-3, 9, and 16, a process 450 of obtaining information for locating an asset includes the stages shown. The process 450 is, however, an example only and not limiting. The process 450 can be altered, e.g., by having stages added, removed, rearranged, combined, performed concurrently, and/or having single stages split into multiple stages. For the discussion of the process 450, only one asset tag 14 is discussed, but more than one asset tag 14 may synch to a particular landmark tag 16. Further, the discussion below discusses synching an asset tag 14 to a first-tier landmark tag 16₁, but the asset tag 14 could synch to a second-tier landmark tag 16₂.

At stage 452, the process 450 includes listening, at an asset tag, for a first listen duration for landmark messages. The wireless communication module 40 listens for the first listen duration d₁ for landmark messages from any of the landmark tags 16. Preferably, the first listen duration is at least as long as a period of landmark message transmissions of the first-tier landmark tags 16₁.

At stage 454, the process 450 includes receiving, at the asset tag during the first listen duration, at least one landmark message from each of one or more landmark tags. The wireless communication module 40 receives a landmark message from at least one of the landmark tags 16. The wireless communication module 40 may receive one or more landmark messages from a single second-tier landmark tag 16₂, a single first-tier landmark tag 16₁, multiple second-tier landmark tags 16₂, multiple first-tier landmark tags 16ₖ, or any combination of these (e.g., one second-tier landmark tag 16₂ and multiple first-tier landmark tags 16′).

At stage 456, the process 450 includes selecting a synched landmark tag from the one or more landmark tags. The processor 30 may select the synched landmark tag 16ₛ, from the landmark tag(s) 16 from which a landmark message was received, in a variety of manners, e.g., randomly, as the closest landmark tag 16 (e.g., based on trilateration location of the asset tag 14 and known locations of the landmark tags 16), as the presumably closest landmark tag 16 (e.g., the landmark tag 16 with a highest corresponding RSSI of a received landmark message), as the presumably closest first-tier landmark tag 16₁ (e.g., by determining the first-tier landmark tag 16₁ with a highest corresponding RSSI of a received landmark message), etc. If the synched landmark tag 16, is selected from the first-tier landmark tags 16₁, then the processor 30 may only determine the RSSI for each first-tier landmark tag 16, from which at least one landmark message was received. The RSSI for a given landmark tag 16 may be the RSSI for a single landmark message if only one landmark message is received is received from that landmark tag 16 during the first listen duration. The RSSI for a given landmark tag 16 may be a combination, e.g., average, of RSSIs of multiple landmark messages if more than one landmark message is received from that landmark tag 16 during the first listen duration.

At stage 458, the process 450 includes abstaining from listening, at the asset tag, for landmark messages until approximately a subsequent transmission time of a synched landmark message corresponding to the synched landmark tag. The asset tag 14, e.g., the wireless communication module 40 and any other appropriate portion of the asset tag 14, sleeps until about the time of a subsequent, e.g., the text, transmission of the synched landmark message. The reduction of operations, including not listening for landmark messages, helps to reduce power consumption and thus conserve battery power and lengthen battery life.

At stage 460, the process 450 includes waking up at approximately the subsequent transmission time of the synched landmark tag to listen, at the asset tag, for landmark messages for a second listen duration such that the asset tag listens for the landmark messages during the next transmission time, wherein the first listen duration is longer than the second listen duration. The asset tag 14, e.g., the wireless communication module 40 and any other sleeping portion, at least for landmark messages, wakes up and listens for incoming landmark messages. The asset tag 14 is synched to the synched landmark tag 16, in that the asset tag 14 wakes up relative to the transmission time of the synched landmark message such that the asset tag 14 can listen to (e.g., receive and process) the beginning of the synched landmark message. That is, the beginning of the second listen window is before the beginning of the synched landmark message. The second listen duration is shorter than the first listen duration, for example because the asset tag 14 is synched to the transmission time of the synched landmark tag, and also because the asset tag 14 is concerned with receiving (or not receiving) only the synched landmark message. The second listen duration is preferably long enough such that the asset tag 14 listens to the entire synched landmark message before the asset tag 14 sleeps again.

The asset tag 14 may change from listening for the second listen duration based on a received signal or lack thereof during the second listen window. For example, if the RSSI of the synched landmark message is significantly different (higher or lower) relative to the RSSI of the synched landmark message previously received, e.g., in the most recent reception of the synched landmark message, then the asset tag 14 may change to a different listen duration such as the first listen duration. Alternatively, if the RSSI of a landmark signal received during the second listen window other than the synched landmark message is higher than the RSSI of the synched landmark signal received during the second listen window, then the asset tag 14 may change to a different listen duration such as the first listen duration. Further, if the synched landmark tag is not received during the second listen window, or has not begun enough before the end of the second listen window to be complete within the second listen window, then the asset tag 14 may change to a different listen duration such as the first listen duration.

Further Considerations

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

A wireless communication network does not have all communications transmitted wirelessly, but is configured to have at least some communications transmitted wirelessly.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

What is claimed is:

1. A method of obtaining information for locating an asset, the method comprising:
listening, at an asset tag, for a first listen duration for landmark messages;
receiving, at the asset tag during the first listen duration, at least one landmark message from each of one or more landmark tags;
selecting a synched landmark tag from the one or more landmark tags;
abstaining from listening, at the asset tag, for landmark messages until approximately a subsequent transmission time of a synched landmark message corresponding to the synched landmark tag; and
waking up at approximately the subsequent transmission time of the synched landmark message to listen, at the asset tag, for landmark messages for a second listen duration such that the asset tag listens for the landmark messages during the subsequent transmission time;
wherein the first listen duration is longer than the second listen duration.

2. The method of claim 1 wherein the one or more landmark tags comprise a plurality of landmark tags including one or more landmark tags of a first type and one or more landmark tags of a second type, and wherein selecting the synched landmark tag comprises determining, at the asset tag, a received signal strength corresponding to each of the one or more landmark tags of the first type and selecting as the synched landmark tag the landmark tag of the first type corresponding to a highest determined received signal strength of a corresponding landmark message.

3. The method of claim 2 wherein the one or more landmark tags of the second type have a higher transmission power and a higher landmark message transmission frequency than the one or more landmark tags of the first type.

4. The method of claim 1 wherein the asset tag listens for the second duration multiple instances between consecutive instances of listening for the first listen duration.

5. The method of claim 1 wherein the asset tag changes from listening for the second listen duration to listening for the first listen duration in response to:
receiving a landmark message from a landmark tag from which no landmark message was received in a most-recent instance of listening for the second listen duration or in a most-recent instance of listening for the first listen duration; or
a received signal strength of a landmark message received from the synched landmark tag during the second duration being significantly different from a previously-received signal strength of a previously-received landmark message from the synched landmark tag.

6. The method of claim 1 wherein the second listen duration is long enough that the asset tag listens during an entire transmission window of the synched landmark message.

7. An asset tag comprising:
a wireless communication module communicatively;
a memory; and
a processor, communicatively coupled to the wireless communication module and the memory, configured to:
cause the wireless communication module to listen for a first listen duration for landmark messages;
select a synched landmark tag from one or more landmark tags from each of which at least one landmark message is received during the first listen duration;
cause the wireless communication module to abstain from listening for landmark messages until approximately a subsequent transmission time of a synched landmark message corresponding to the synched landmark tag; and
cause the wireless communication module to wake up at approximately the subsequent transmission time of the synched landmark message to listen for landmark messages for a second listen duration such that the asset tag listens for the landmark messages during the subsequent transmission time;
wherein the first listen duration is longer than the second listen duration.

8. The asset tag of claim 7 wherein the processor is configured to select the synched landmark tag by determining a received signal strength corresponding to each of one or more landmark tags of a first type, from among one or more landmark tags of the first type and one or more landmark tags of a second type of the one or more landmark tags from each of which at least one landmark message is received during the first listen duration, and selecting as the synched landmark tag the landmark tag of the first type corresponding to a highest determined received signal strength of a corresponding landmark message.

9. The asset tag of claim 8 wherein the one or more landmark tags of the second type have a higher transmission power and a higher landmark message transmission frequency than the one or more landmark tags of the first type.

10. The asset tag of claim 7 wherein the processor is configured to cause the wireless communication module to listen for the second duration multiple instances between consecutive instances of listening for the first listen duration.

11. The asset tag of claim 7 wherein the processor is configured to cause the wireless communication module to change from listening for the second listen duration to listening for the first listen duration in response to:
the wireless communication module receiving a landmark message from a landmark tag from which no landmark message was received in a most-recent instance of listening for the second listen duration or in a most-recent instance of listening for the first listen duration; or
a received signal strength of a landmark message received from the synched landmark tag during the second duration being significantly different from a previously-received signal strength of a previously-received landmark message from the synched landmark tag.

12. The asset tag of claim 7 wherein the second listen duration is long enough that the wireless communication module listens during an entire transmission window of the synched landmark message.

13. An asset tag comprising:
wireless communication means for communicating with landmark tags;
processor means, communicatively coupled to the wireless communication module and the memory, for:
causing the wireless communication module to listen for a first listen duration for landmark messages;
selecting a synched landmark tag from one or more landmark tags from each of which at least one landmark message is received during the first listen duration;
causing the wireless communication module to abstain from listening for landmark messages until approximately a subsequent transmission time of a synched landmark message corresponding to the synched landmark tag; and
causing the wireless communication module to wake up at approximately the subsequent transmission time of the synched landmark message to listen for landmark messages for a second listen duration such that the asset tag listens for the landmark messages during the subsequent transmission time;
wherein the first listen duration is longer than the second listen duration.

14. The asset tag of claim 13 wherein the processor means are configured to select the synched landmark tag by determining a received signal strength corresponding to each of one or more landmark tags of a first type, from among one or more landmark tags of the first type and one or more landmark tags of a second type of the one or more landmark tags from each of which at least one landmark message is received during the first listen duration, and selecting as the synched landmark tag the landmark tag of the first type corresponding to a highest determined received signal strength of a corresponding landmark message.

15. The asset tag of claim 14 wherein the one or more landmark tags of the second type have a higher transmission power and a higher landmark message transmission frequency than the one or more landmark tags of the first type.

16. The asset tag of claim 13 wherein the processor means are configured to cause the wireless communication module to listen for the second duration multiple instances between consecutive instances of listening for the first listen duration.

17. The asset tag of claim 13 wherein the processor means are further for causing the wireless communication module to change from listening for the second listen duration to listening for the first listen duration in response to:
the wireless communication module receiving a landmark message from a landmark tag from which no landmark message was received in a most-recent instance of listening for the second listen duration or in a most-recent instance of listening for the first listen duration; or
a received signal strength of a landmark message received from the synched landmark tag during the second duration being significantly different from a previously-received signal strength of a previously-received landmark message from the synched landmark tag.

18. The asset tag of claim 13 wherein the second listen duration is long enough that the wireless communication module listens during an entire transmission window of the synched landmark message.

19. A processor-readable storage medium comprising processor-readable instructions configured to cause a processor to:
cause a wireless communication module to listen for a first listen duration for landmark messages;
select a synched landmark tag from one or more landmark tags from each of which at least one landmark message is received during the first listen duration;
cause the wireless communication module to abstain from listening for landmark messages until approximately a subsequent transmission time of a synched landmark message corresponding to the synched landmark tag; and
cause the wireless communication module to wake up at approximately the subsequent transmission time of the synched landmark message to listen for landmark messages for a second listen duration such that the asset tag listens for the landmark messages during the subsequent transmission time;
wherein the first listen duration is longer than the second listen duration.

20. The processor-readable storage medium of claim 19 wherein the instructions configured to cause the processor to select are configured to cause the processor to determine a received signal strength corresponding to each of one or more landmark tags of a first type, from among one or more landmark tags of the first type and one or more landmark tags of a second type of the one or more landmark tags from each of which at least one landmark message is received during the first listen duration, and to select as the synched landmark tag the landmark tag of the first type corresponding to a highest determined received signal strength of a corresponding landmark message.

21. The processor-readable storage medium of claim 20 wherein the one or more landmark tags of the second type have a higher transmission power and a higher landmark message transmission frequency than the one or more landmark tags of the first type.

22. The processor-readable storage medium of claim 19 wherein the instructions configured to cause the processor to cause the wireless communication module to listen for the second duration are configured to cause the processor to cause the wireless communication module to listen for the second duration multiple instances between consecutive instances of listening for the first listen duration.

23. The processor-readable storage medium of claim 19 further comprising instructions configured to cause the processor to cause the wireless communication module to change from listening for the second listen duration to listening for the first listen duration in response to:
the wireless communication module receiving a landmark message from a landmark tag from which no landmark message was received in a most-recent instance of listening for the second listen duration or in a most-recent instance of listening for the first listen duration; or
a received signal strength of a landmark message received from the synched landmark tag during the second duration being significantly different from a previously-received signal strength of a previously-received landmark message from the synched landmark tag.

24. The processor-readable storage medium of claim 19 wherein the second listen duration is long enough that the wireless communication module listens during an entire transmission window of the synched landmark message.
